(19) United States
(12) Patent Application Publication
(10) Pub. No.: US 2025/0130932 A1
(43) Pub. Date: Apr. 24, 2025

(54) AUTOMATED TESTING TO CHECK FOR USER INTERFACE TRUNCATION

(71) Applicant: DELL PRODUCTS L.P., Round Rock, TX (US)

(72) Inventors: Wanqing Zheng, Shanghai (CN); Yinghui Liu, Shanghai (CN); Dong Zhang, Shanghai (CN); Wei Wei Jiang, Shanghai (CN)

(21) Appl. No.: 18/505,411

(22) Filed: Nov. 9, 2023

(30) Foreign Application Priority Data
Oct. 20, 2023 (CN) 202311368941.6

(51) Int. Cl. G06F 11/36

(52) U.S. Cl. CPC G06F 11/3696; G06F 11/3698

(57) ABSTRACT

An information handling system detects whether a text element in a graphical user interface is truncated by comparing the text element with an expected text element using a pattern-matching algorithm. The system also detects whether a non-text element in the graphical user interface is truncated by comparing the non-text element to a reconstructed copy of the non-text element.

### FIELD OF THE DISCLOSURE

The present disclosure generally relates to information handling systems, and more particularly relates to automated testing to check for a user interface truncation.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system detects whether a text element in a graphical user interface is truncated by comparing the text element with an expected text element using a pattern-matching algorithm. The system also detects whether a non-text element in the graphical user interface is truncated by comparing the non-text element to a reconstructed copy of the non-text element.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of a graphical user interface (GUI) test system to automatically check for GUI element truncations, according to an embodiment of the present disclosure;

FIG. 3 is a flowchart of a method to automatically check for GUI element truncations, according to an embodiment of the present disclosure;

FIG. 4 is a diagram of a GUI with recognized text elements and non-text elements after an automatic layout analysis, according to an embodiment of the present disclosure;

FIG. 5 is a diagram of a GUI image with recognized text regions and non-text regions after an automatic layout analysis, according to an embodiment of the present disclosure;

FIGS. 6 and 7 are diagrams of GUI images with text that are dynamically filled with different content at runtime after an automatic layout analysis, according to an embodiment of the present disclosure; and

FIGS. 8 and 9 are diagrams of non-text regions with truncation issues, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

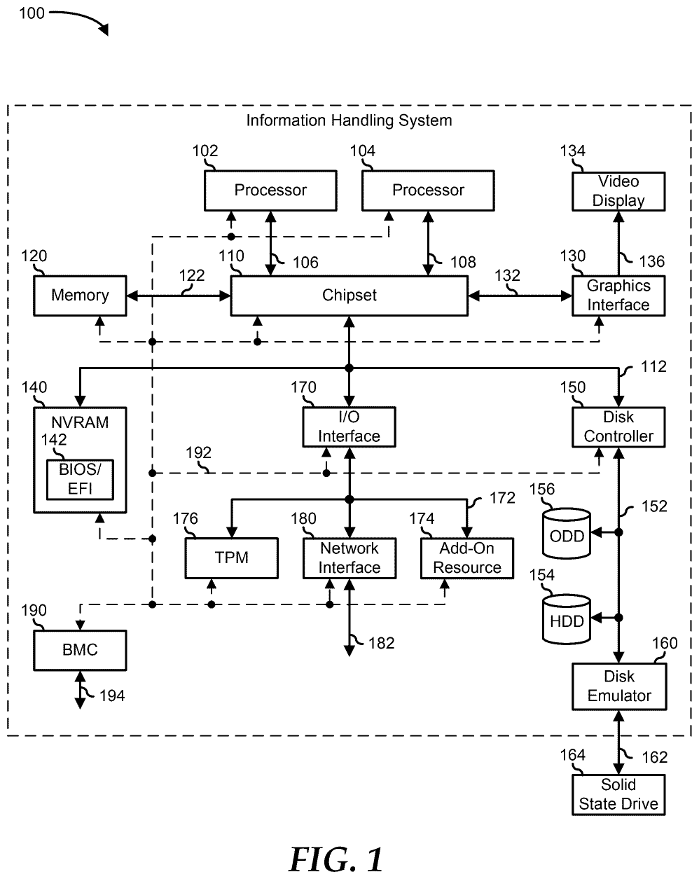

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC)® channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I2C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

A typical graphical user interface (GUI) includes elements such as text, input controls, navigational components, and informational components. Although the GUI elements may appear normal at a certain resolution, operating system, or browser, these elements can be inadvertently truncated when displayed using a different resolution and/or localized to a different language. For example, text and GUI regions may be truncated or cut off. GUI testing includes detecting the GUI elements and determining truncations of the GUI elements if any. Typically, testers identify the truncation issues manually by looking at the GUI layout during the testing process. However, with multiple languages, operating systems, browsers, and resolutions, manually identifying truncated GUI elements is tedious, time-consuming, and expensive. To address these and other concerns, the present disclosure provides a system and method for automated GUI testing that can check for truncations of the GUI elements.

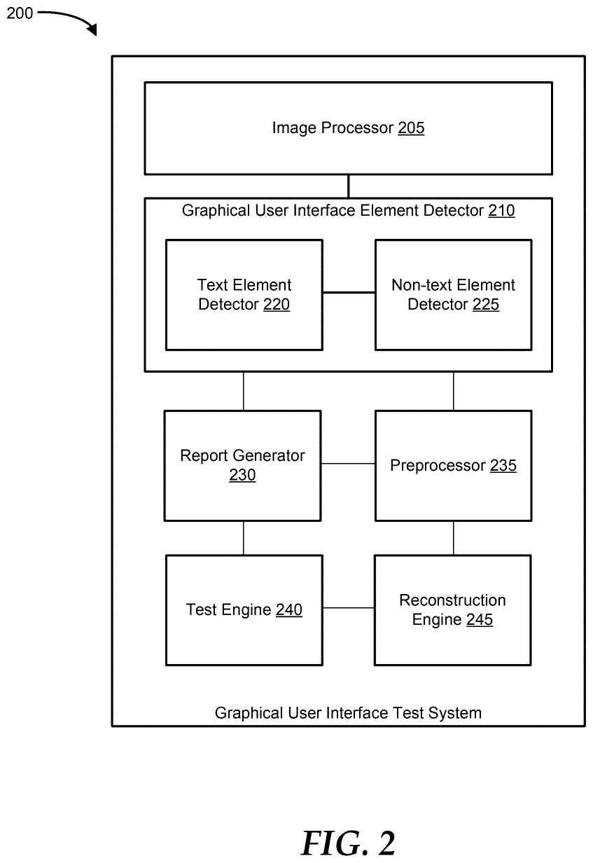

FIG. 2 shows a GUI test system 200 to automatically check for GUI element truncations. GUI test system 200, which may be implemented as a representational state transfer service in information handling system 100 of FIG. 1, includes an image processor 205, a GUI element detector 210, a report generator 230, a preprocessor 235, a test engine 240, and a reconstruction engine 245. GUI element detector 210 includes a text element detector 220 and a non-text element detector 225. GUI test system 200 is an automated testing framework that may be configured to automatically check for truncation in GUI elements of an application and generate a report on its findings.

During testing, several screens or pages of an application may be provided to GUI test system 200. One of the screens or pages may be used as a base GUI image, wherein its GUI elements may be used as a basis for comparison with the other screens or pages to detect truncation issues. The base GUI image may have been pre-verified to not have truncated GUI elements. GUI test system 200 may iterate through the other screens or pages of the application which may be in a different resolution and/or languages to compare each one with the base GUI image.

Image processor 205 may be configured to capture an image of a GUI which can be a screenshot of the screens or the pages of the application. In addition, image processor 205 may extract expected text elements from a base GUI image, such as by using an optical character recognition technology. The expected text elements may be stored in one of several formats such as a JavaScript Object Notation file or similar. The expected text elements may be used as a baseline for comparison of text elements recognized by GUI element detector 210. The information associated with the expected GUI elements may be transmitted to test engine 240. In addition, the base GUI image may be used as a pre-trained model by text element detector 220 to detect text elements in the GUI images to be tested. Each of the GUI images to be tested may have a different resolution and/or language than the GUI base image.

The GUI images to be tested may be transmitted to preprocessor 235 for pre-processing which includes removing noise associated with the image content of the GUI images. Preprocessor 235 may also adjust the coloring of the GUI elements to a single color, such as gray prior to transmitting to GUI element detector 210. This may assist in a more accurate GUI element detection.

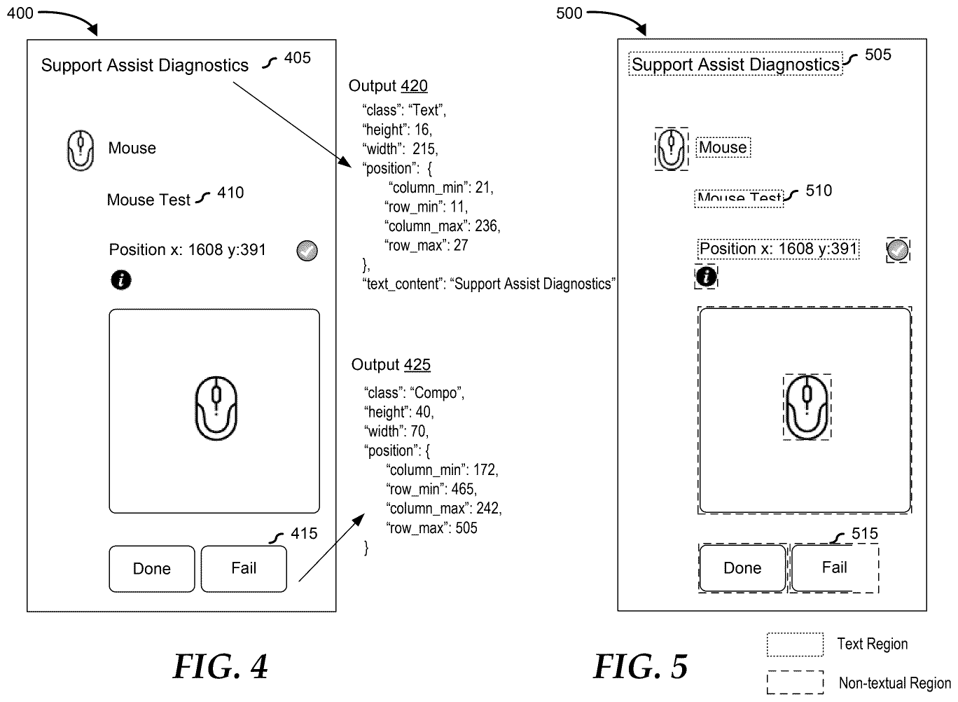

GUI element detector 210 may be configured to identify or recognize GUI elements in the test GUI image. GUI element detector 210 may be configured to determine a position, size, and class of the GUI elements and provide an output similar to outputs shown in FIG. 4. In addition, GUI element detector 210 may produce regions that stand for potential layout blocks of GUI elements. A region associated with a text element may have a different color than a region associated with a non-text element for ease in distinguishing the regions.

Text element detector 220 may be configured to detect the text elements. Non-text element detector 225 may be configured to detect the non-text elements, such as a control element, an icon, a cursor, etc. Text element detector 220 may use a deep learning method, such as an efficient and accurate scene text (EAST) detector to recognize text elements including text inside a non-text element region using the base GUI image as a model. Text element detector 220 may detect text elements in test GUI images by learning GUI element features and their compositions from one or more base GUI images. Text element detector 220 may produce text regions that stand for potential text elements, such as shown in FIG. 5. In addition, text element detector 220 may account for text content and layout characteristics of the text element, such as height, width, class, etc.

Non-text element detector 225 may be configured to use a top-down computer vision technology to detect instances and classify the non-textual elements in the test GUI image. In addition, non-text element detector 225 may account for a boundary, shape, texture, and layout characteristics of the non-text GUI elements. Non-text element detector 225 may produce non-text regions that stand for potential non-text GUI elements as shown in FIG. 5. Based on the non-text regions provided by non-text element detector 225, reconstruction engine 245 may be configured to reconstruct shapes detected by non-text element detector 225 so that a region associated with a non-textual element is closed or not.

Test engine 240 may be configured to check whether recognized text elements in the test GUI images by text element detector 220 are the same as expected text elements in the base GUI image. Test engine 240 may take the outputs from image processor 205 and GUI element detector 210 as inputs. The output from image processor 205 may be used as expected text elements and compared with the output from text element detector 220 using a pattern-matching algorithm to determine whether the text elements in the test GUI image are truncated. Test engine 240 may utilize a shape reconstruction algorithm to determine whether a non-text element detected by non-text element detector 225 is truncated or not. Test engine 240 may provide an output associated with the comparison. Report generator 230 may be configured to generate a report based on the output of test engine 240. The report may identify the GUI elements that are truncated. The report may also identify locations of these GUI elements.

Those of ordinary skill in the art will appreciate that the configuration, hardware, and/or software components of GUI test system 200 depicted in FIG. 2 may vary. For example, the illustrative components within GUI test system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description. Accordingly, the aspects of the present disclosure may be applied or adapted for use in many other contexts.

The components of GUI test system 200 may be implemented in hardware, software, firmware, or any combination thereof. Additionally, or alternatively, GUI test system 200 may include various additional components in addition to those that are shown in FIG. 2. Connections between components may be omitted for descriptive clarity. In various embodiments, GUI test system 200 may not include each of the components shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into one or more processor(s) as a system-on-a-chip.

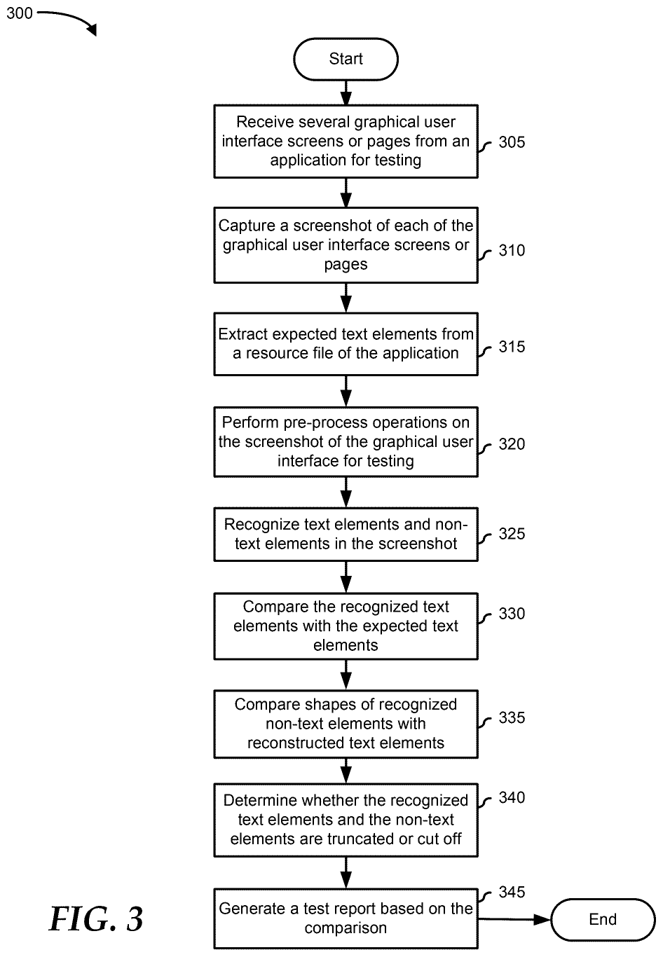

FIG. 3 illustrates a method 300 for performing automated GUI testing for detecting truncation issues of GUI elements. Method 300 may be performed by one or more components of GUI test system 200 of FIG. 2. However, while embodiments of the present disclosure are described in terms of GUI test system 200 of FIG. 2, it should be recognized that other systems may be utilized to perform the described method. One of skill in the art will appreciate that this flowchart explains a typical example, which can be extended to advanced applications or services in practice.

Method 300 typically starts at block 305 where a testing interface of a testing framework receives several application GUI screens or pages for testing. One of the GUI screens or pages may be used as a base or model for detecting GUI elements in the other GUI screens or pages. In one embodiment, the application may include a resource file, such as a .resx file, which is non-executable data that is typically deployed with the application. The resource file may include data in various forms, such as strings and images associated with the application. For example, the resource file may include the expected text elements. The resource file may be one of various formats, such as a JavaScript Notation format, an Extensible Markup Language format, or similar.

The method may proceed to block 310, where the testing framework may capture an image, such as a screenshot of each of the GUI screens or pages for testing. Each of the screenshots may also be referred to as a GUI image. The method may proceed to block 315 where the testing framework may extract text elements from a resource file associated with the base GUI image of the application. The base GUI image may be pre-determined by a user to not include truncated text elements and non-text elements. The extracted text may be used as expected text for comparison with detected GUI elements in the GUI images being tested. The method may proceed to block 320.

At block 320, the pre-processor may pre-process the GUI images to be tested for truncation issues using computer vision technology. For example, the pre-processor may remove noise and convert different colors of the GUI elements into gray. The method may then proceed to block 325 where the GUI element detector may use a deep learning scene text detector, such as the EAST detector to recognize text elements in the GUI images. The deep learning scene text detector may provide information associated with recognized text elements, such as height, width, position, etc., as shown in output 420 of FIG. 4. In addition, the GUI element detector may use computer vision technology to detect non-text elements in the GUI images. The computer vision technology may be used to detect contour key points of non-text regions, such as depicted in output 425 of FIG. 4. The method may proceed to block 330.

At block 330, the test engine may compare the recognized text elements with the expected text elements. For comparing the text elements, a pattern-matching algorithm may be used to compare the recognized text with the expected text. For example, the method may compare text region 505 with text_content in output 420 of text element 405. The test engine may also compare the position, height, width, and/or other properties of the text regions with the expected text. For example, the test engine may compare the height and width of text region 510 with the height and width in output 420 of text element 410.

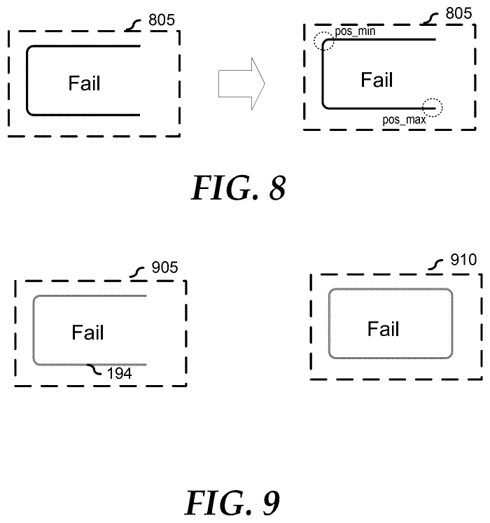

The method may proceed to block 335 where the test engine may compare shapes of recognized or detected non-text elements or regions with reconstructed non-text elements or regions. A shape reconstruction algorithm may be used to cut out the non-text element region based on its contour key points from the GUI image and save it as an original image similar to FIG. 8. The original image is preprocessed by changing its color to gray color before saving the copy. The reconstruction engine may then override the contours of the copy of the original image, generate a reconstruction, and save it as a reconstructed copy. The shape of the original image may be compared with the shape of the reconstructed copy to determine if the shapes match or are identical as depicted in FIG. 9. The method may proceed to block 340.

At block 340, the test engine may determine whether the detected or recognized text elements and the non-text elements are truncated or cut off. If the detected or recognized text elements are not identical to the expected text elements based on the comparison at block 330, then the detected or recognized text elements may be truncated or cut off.

The comparison of the detected or recognized non-text elements at block 335 may return a metric, wherein the lower the metric value is, the better the match. A threshold may be used, such as if the metric value returned is equal to or lower than the threshold, the images may be deemed identical. If the metric value returned is greater than the threshold, the images may not be deemed identical. In one example, the threshold may be set to 0.3, which can be adjusted by a tester. The threshold may be different for each non-text element being evaluated. If the detected or recognized image does not match or is not identical to the reconstructed image, then the detected or recognized image may be truncated or cut off. Because the information associated with the non-text element is used, the shape reconstruction algorithm may work for any GUI implementation.

Block 310 through 335 may be performed for each of the received graphical user interface screens or pages. After processing each of the GUI images, the method may proceed to block 345 where a report may be generated based on the results of the comparison. The report may be in one of several formats, such as a JavaScript Object Notation format or similar.

FIG. 4 shows an example of a GUI image 400 with recognized text elements and non-text elements after an automatic layout analysis. GUI image 400 includes text elements 405 and 410 and a non-text element 415. In this example, an output 420 is associated with recognized text element 405 while output 420 is associated with non-text element 415. Accordingly, output 420 includes information associated with text element 405, such as its class, height, width, position, and text content. In this example, text element 405 is assigned a class text. The height, width, and position may be in pixels. The height and width refer to the height and width of the text. The position shows the location of the text element in the screenshot, which is further identified by its coordinates, such as column minimum, row minimum, column maximum, and row maximum (column_min, row_min, column_max, and row_max respectively). For example, the column_min may refer to a leftmost column occupied by the GUI element, while the row_min may refer to a bottommost row. Accordingly, the column_max may refer to a rightmost column occupied by the GUI element, while the row_max may refer to the topmost row.

Similarly, output 425 includes information associated with non-text element 415, such as its class, height, width, and position. In this example, non-text element 415 is assigned a class composition control. The height, width, and position may be in pixels. The height and width refer to the height and width of the text. The position shows the location of the non-text element in the screenshot, which is further identified by column_min, row_min, column_max, and row_max.

FIG. 5 shows an example of a GUI image 500 that shows recognized text regions and non-text regions after an automatic layout analysis. The text regions are associated with the text elements while the non-text regions are associated with non-text elements, respectively. In this example, GUI image 500 includes text regions 505 and 510 and non-text regions 515. In this example, text region 505 is associated with text element 405 and is not truncated. Text region 510 is associated with text element 410 and is truncated. Non-text region 515 is associated with non-text element 415 and is truncated.

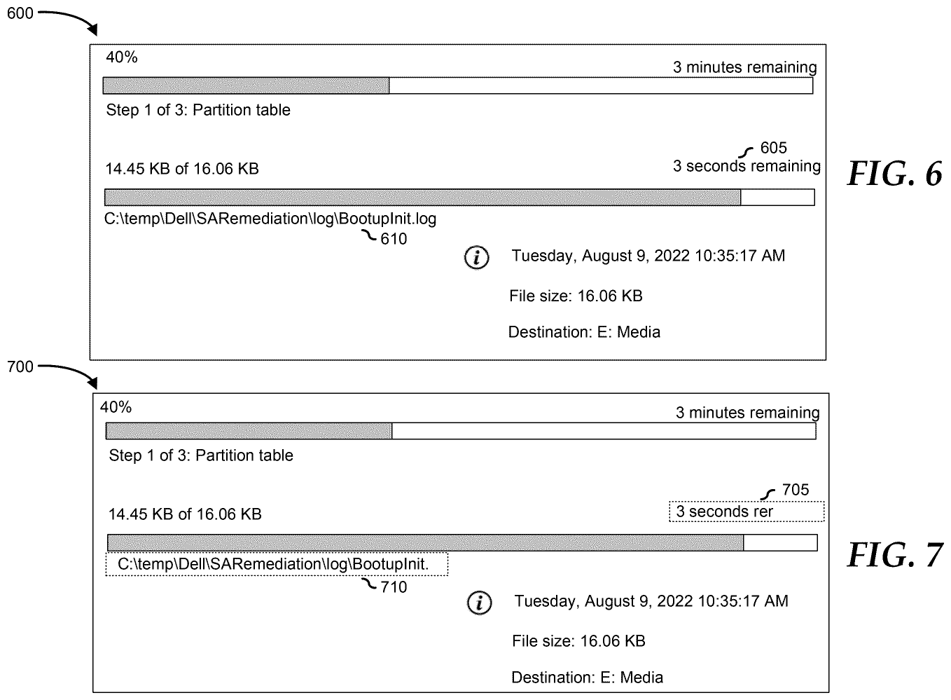

FIG. 6 shows an example of a GUI image 600 with text that is dynamically filled with different content at runtime after an automatic layout analysis. GUI image 600 includes text elements 605 and 610. FIG. 7 shows an example of a GUI image 700 which is similar to GUI image 600. GUI image 700 includes text regions 705 and 710 which correspond to text elements 605 and 610, respectively. In this example, both text regions 705 and 710 are truncated. Because the detected text in GUI image 700 changes dynamically, the GUI test system may utilize regular expressions to match the detected text to the expected text shown in GUI image 600. Table 1 shows examples of regular expressions that may be used in comparing expected text to the detected text.

TABLE 1

| EXPECTED | DETECTED | |
|---|---|---|
| VALUE | VALUE | PATTERN |
| { } minutes | 3 minutes remaining | re.search(r“[1-9]\hat{ } minutes |
| remaining | | remaining”, D_v) |
| Null | C:\temp\Dell\ | Path(D_v).is_dir( ) or Path |
| | SARemediation\log\ | (D_v).is_file |
| | Bootupinit.log | |
| { }% | 40% | re.search(r“[1-9]\hat{ } %”, D_v) |

In addition, there are instances wherein texts may be displayed in close proximity to other GUI elements, such as symbols as shown in Table 2 below. These instances may pose a challenge for accurate text detection. Accordingly, these other GUI elements may be taken into account by text element detector 220. Table 2 shows examples of how to handle the comparison between the expected text and the detected text when the expected text includes symbols in proximity to characters in the text region. When the detected text includes a portion of the symbols or other GUI elements in proximity to the text, a false negative may be reported. This is because the symbols may be falsely detected as special characters. Accordingly, when comparing the detected text with the expected text, they would not be identical. To address false negatives, the test element detector may filter out symbols from negative test results and do the comparison again, which should result in a positive match.

Table 2 includes an expected value column, an expected appearance column, a detected value column, and a text region column with a filter applied. In this example, the “expected value is “WHAT” which appears next to a symbol “\textcircled{2}.” When a particular symbol like \textcircled{2} is in close proximity to the expected value, the detected value may include a portion of the symbol. In this example, the detected value shows as “) WHAT” which includes a side portion of the symbol \textcircled{2}. Because of this, a false negative may be reported in the test results. To address this issue, the text element detector may apply a symbol filter and perform the comparison between the expected value and the detected value again. At this point, a text region detected as shown inside a box with dash lines in the text region column matches with the expected value and returns a positive match.

In another example, the expected value “BACKUP PROGRESS” appears next to a symbol “\textcircled{4}” The detected value is depicted as “\U2463 BACKUP PROGRESS”, wherein “\U2463” is a Unicode character of the symbol \textcircled{4}. This may show another false negative in the test results. To address this issue, the text element detector may filter out the Unicode character for symbols and/or provide the symbol for the Unicode character “circled digit four” as shown in the text region of the second row. Afterwards, the test engine may perform the comparison again which should result in a positive match.

TABLE 2

| Expected Value | Expected Appearance | Detected Value | Text Region |
|---|---|---|---|
| WHAT | \textcircled{2} WHAT | )WHAT | 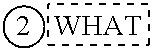 |
| BACKUP PROGRESS | \textcircled{4} BACKUP PROGRESS | \U2463 BACKUP PROGRESS | 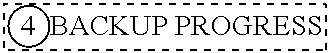 |

FIG. 8 shows a non-text region 805 with a truncation issue and associated contour key point. Non-text region 805 may be a copy or a cut-out of non-text region 515 of FIG. 5. Because non-text region 805 is a rectangle contour key points, such as its minimum and maximum positions (pos_min and pos_max respectively) can be obtained by a detection model which may be based on detected or identified positions as shown in output 425. For example, pos_min may be based on position column_min and position row_min. Pos_max may be based on position column_max and row_max. However, identifying the pos_min and the pos_max may not guarantee that the recognized or detected non-text element in non-text region 805 is closed off and that all the borders exist. In this example, three of the four borders of the non-text element in non-text region 805 exist. As such, to detect if there is an open border the non-text element may be reconstructed based on the output information associated with non-text region 805 which in this example is non-text element 415. When the reconstructed image is identical to a base image then the base image may not be truncated. When the reconstructed image is not identical to the base image, then the base image may be truncated.

FIG. 9 shows a non-text region 905 which may be a modified image based on non-text region 805 after pre-processing. The pre-processing includes adjusting the coloring of the non-textual element to a monochromatic hue, such as in gray, prior to saving the image. This allows for easier comparison between the images as the color of pixels of the non-text element are identical. After pre-processing, non-text region 905 may be copied and contours are drawn based on the contour key points identified in FIG. 8 to reconstruct the truncated shape and close out an open space. This reconstructed image of non-text region 905 may then be saved as non-text region 910. Non-text region 905, which is used as the base image, and non-text region 910 may then be compared to determine if they are identical or not using computer vision technology.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, block 325 and block 330 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
detecting, by a processor, a text element and a non-text element in a graphical user interface;
detecting whether the text element in the graphical user interface is truncated by comparing the text element with an expected text element using a pattern-matching algorithm; and
detecting whether the non-text element in the graphical user interface is truncated by comparing the non-text element to a reconstructed copy of the non-text element.

2. The method of claim 1, wherein the comparing of the text element with the expected text element, includes filtering a symbol.

3. The method of claim 2, wherein the filtering of the symbol is performed when the text element is not identical to the expected text element prior to performing another comparison of the text element with the expected text element.

4. The method of claim 1, wherein the expected text element is extracted from a screenshot.

5. The method of claim 1, wherein the reconstructed copy of the non-text element is generated by overriding contour key points of a copy of the non-text element.

6. The method of claim 1, wherein the detecting of the text element is performed using a deep learning text detector.

7. The method of claim 1, wherein the detecting of the non-text element is performed using computer vision technology.

8. An information handling system, comprising:
a processor; and
a memory storing instructions that when executed cause the processor to perform operations including:
detecting a text element and a non-text element in a graphical user interface;
detecting whether the text element in the graphical user interface is truncated by comparing the text element with an expected text element using a pattern-matching algorithm; and
detecting whether the non-text element in the graphical user interface is truncated by comparing the non-text element to a reconstructed copy of the non-text element.

9. The information handling system of claim 8, wherein the comparing of the text element with the expected text element, includes filtering a symbol.

10. The information handling system of claim 9, wherein the filtering of the symbol is performed when the text element is not identical to the expected text element prior to performing another comparison of the text element with the expected text element.

11. The information handling system of claim 8, wherein the expected text element is extracted from a screenshot.

12. The information handling system of claim 8, wherein the reconstructed copy of the non-text element is generated by overriding contour key points of a copy of the non-text element.

13. The information handling system of claim 8, wherein the reconstructed copy of the non-text element is generated by overriding contour key points of a copy of the non-text element.

14. The information handling system of claim 8, wherein the detecting of the text element is performed using a deep learning text detector.

15. The information handling system of claim 8, wherein the detecting of the non-text element is performed using computer vision technology.

16. A non-transitory computer-readable medium to store instructions that are executable to perform operations comprising:
detecting whether a text element in a graphical user interface is truncated by comparing the text element with an expected text element using a pattern-matching algorithm; and
detecting whether a non-text element in the graphical user interface is truncated by comparing the non-text element to a reconstructed copy of the non-text element.

17. The non-transitory computer-readable medium of claim 16, wherein the comparing of the text element with the expected text element, includes filtering a symbol.

18. The non-transitory computer-readable medium of claim 17, wherein the filtering of the symbol is performed when the text element is not identical to the expected text element prior to performing another comparison of the text element with the expected text element.

19. The non-transitory computer-readable medium of claim 16, wherein the expected text element is extracted from a screenshot.

20. The non-transitory computer-readable medium of claim 16, wherein the reconstructed copy of the non-text element is generated by overriding contour key points of a copy of the non-text element.
